(19) United States
(12) Patent Application Publication
(10) Pub. No.: US 2025/0256134 A1
(43) Pub. Date: Aug. 14, 2025

(54) BREATHING APPARATUS MONITORING

(71) Applicant: Dräger Safety AG & Co. KGaA, Lubeck (DE)

(72) Inventors: Larry Qing Lu, Leeds (GB); Norman John Webster, Northumberland (GB); Thomas Eric Vardy, Howden (GB); Konstantinos Goutsos, Newcastle upon Tyne (GB)

(21) Appl. No.: 19/047,791

(22) Filed: Feb. 7, 2025

(30) Foreign Application Priority Data
Feb. 8, 2024 (EP) 24386012.9

(51) Int. Cl. A62B 9/00

(52) U.S. Cl. CPC A62B 9/006

(57) ABSTRACT

There is disclosed a method for monitoring a user of a breathing apparatus (BA) of a network, wherein the method is performed by a wireless device of the network, and wherein the wireless device is coupled to a network node of the network that is configured to route communications between the BA and the wireless device. The method may comprise, in response to determining that an incident has occurred, determining a time discrete parameter associated with the BA. The incident may correspond to a loss of connection between the BA and the network node. The determination may be based on whether information, obtained from the BA prior to the occurrence of the incident, meets a first criterion. The information may comprise user breathing rate information.

### CROSS-REFERENCE TO RELATED APPLICATIONS

This application claims the priority of European Patent Application No. 24386012.9, filed on Feb. 8, 2024, and titled “Breathing Apparatus Monitoring”, which is hereby incorporated by reference in its entirety for all nonlimiting purposes.

### TECHNICAL FIELD

This disclosure relates to monitoring a user of a breathing apparatus of a network and, more specifically, to methods and apparatus for handling a loss of connection associated with the breathing apparatus.

### BACKGROUND

Emergency services (e.g., fire services) are organisations that ensure public safety, security, and health by addressing and resolving different emergencies. As such, emergency services require every advantage possible when responding to emergencies. This is especially true as emergency services are required to respond to increasingly complex emergencies. Emergency services personnel are commonly equipped with specialised equipment to protect the personnel and allow them to respond to a range of emergencies.

For example, firefighters are often exposed to toxic environments created by combustible materials. Such environments expose firefighters to smoke, oxygen deficiency, elevated temperatures, poisonous atmospheres, and violent air flows. To combat some of these risks, each firefighter will normally carry a breathing apparatus (BA). The proper management of such specialised equipment can mean the difference between a successful response to an emergency and catastrophe.

Some BA systems comprise devices such as telemetry equipment to transmit status information regarding the BA and/or the user of the BA. The information is generally transmitted to a base station. Once received by the base station, an entry control officer (ECO) will often interpret the information to determine parameters such as the firefighter's retreat time and remaining supply of breathing gas. Such parameters are important to ensure the safety of the firefighter.

When responding to an emergency, firefighters will routinely enter areas where signals sent from the telemetry equipment of the BA cannot be received by a base station. For instance, a firefighter may move out of range of the base station, or the transmitted signals may be blocked in some way. In these situations, the ECO must manually determine the parameters of interest based on the last information successfully transmitted from the BA to the base station. This process is time consuming, error prone, and distracts the ECO from managing other key facets of the emergency response.

It will therefore be understood that improvements to existing BA telemetry techniques are desirable.

### SUMMARY

As mentioned above, there is a desire for improved BA telemetry techniques. Therefore, according to a first aspect, there is provided a method for monitoring a user of a breathing apparatus (BA) of a network. The method is performed by a wireless device of the network. The wireless device is coupled to a network node of the network that is configured to route communications between the BA and the wireless device. The method comprises, in response to determining that an incident has occurred, determining a time discrete parameter associated with the BA. The incident corresponds to a loss of connection between the BA and the network node, and the determination is based on whether information, obtained from the BA prior to the occurrence of the incident, meets a first criterion. The information comprises user breathing rate information.

The wireless device and the network node may be separate devices which are coupled together, for example, wirelessly (e.g., via one or more wireless signals).

It will be understood that a loss of connection between the BA and the network node may be any loss of connection between the BA and the network node. For example, the loss of connection may be caused by one or more of a physical obstruction blocking a signal (e.g., transmitted from the BA), electromagnetic interference, a loss of power (e.g., of the BA and/or the network node), an equipment failure (e.g., of the BA and/or the network node), or for any other reason.

It will be understood that a time discrete parameter may be a parameter measurable at an instantaneous moment in time. Alternatively, or in addition, the time discrete parameter may correspond to a parameter determined periodically and/or continuously with respect to time. As such, in an example, determining a time discrete parameter, as described herein, may comprise determining one or more values for the parameter over time.

If the information meets the first criterion, the time discrete parameter may be determined using the information obtained from the BA prior to the occurrence of the incident. If the information does not meet the first criterion, the time discrete parameter may be determined using pre-configured breathing rate information.

The first criterion may be configured at the wireless device. For example, the first criterion may be configured in response to receiving an input (e.g., via a user interface of the wireless device) indicative of the first criterion (e.g., by an operator of the wireless device). The operator of the wireless device may be an entry control officer, ECO. The first criterion may be configurable during the incident as referred to herein.

The pre-configured breathing rate information may comprise a breathing profile of the user.

The pre-configured breathing rate information may comprise a constant breathing rate parameter.

The pre-configured breathing rate information may be represented by a formula, or a lookup table used to determine an estimated breathing rate of a user. The pre-configured breathing rate information may account for age, height, weight, and/or any other physiological parameters of a user. A breathing profile of a user may represent a customized breathing rate information. The breathing profile may be determined either empirically or analytically based on one or more physiological parameters of the user.

The information may exclusively comprise user breathing rate information. The information may comprise user breathing rate information in addition to other information. User breathing rate information may include current and/or real time breathing rate information. User breathing rate information may additionally or alternatively include previous and/or historic user breathing rate information. The user breathing rate information may comprise, for example, last known breathing rate(s) of the user prior to the occurrence of the incident as defined herein. Alternatively, or in addition, other information may include physiological information such as heart rate information, body temperature information, and/or blood oxygen saturation information etc. Other information may include metadata such as a timestamp, user identifier (ID), date, and/or equipment ID etc.

During normal operation, the BA may record and/or transmit the information at regular intervals and/or in response to a predetermined event. During an incident, the BA may record and/or store (e.g., retain) the information (e.g., to enable the information to later be transmitted by the BA and/or extracted from the BA).

The time discrete parameter associated with the BA may be a time discrete pressure value.

The time discrete pressure value may correspond to a pressure of a breathing gas cylinder of the BA. The time discrete pressure value may correspond to an intermediate or lower pressure in a secondary or tertiary stage of the BA.

The information may meet the first criterion if the user breathing rate information comprised in the information corresponds to a user breathing rate that is greater than or equal to a threshold breathing rate. The information may not meet the first criterion if the user breathing rate information comprised in the information corresponds to a user breathing rate that is less than the threshold breathing rate.

Determining that the incident has occurred may comprise receiving, from the network node, a message comprising information indicative of the loss of connection between the BA and the network node. Alternatively, or in addition, determining that the incident has occurred may comprise determining that a set period of time has elapsed in which no information is obtained from the BA.

The method may comprise determining the user breathing rate based on the information obtained from the BA.

Determining the user breathing rate based on the information may comprise using a formula and/or a lookup table. For example, a formula and/or lookup table may be used to convert/translate/interpret the information into the user breathing rate. The conversion/translation/interpretation may take place within the wireless device. The wireless device may hand off the determination and the information to a separate device and then receive the user breathing rate from the separate device.

The user breathing rate information comprised in the information may comprise information indicative of a BA fluid consumption. The BA fluid consumption may comprise a measured BA fluid consumption and/or an estimated BA fluid consumption. The BA fluid consumption may be measured and/or estimated by the BA (e.g., a breathing detector of the BA). In an example, the BA fluid consumption may correspond to a rate of fluid consumption through a fluid line of the BA. The BA fluid may comprise a breathable fluid (e.g., air).

The method may further comprise determining, based on the time discrete parameter associated with the BA, a remaining capacity of the BA.

The method may further comprise, if the determined remaining capacity of the BA meets a second criterion: generating an alert notification indicative that the determined remaining capacity of the BA meets the second criterion. Alternatively, or in addition, the method may comprise initiating transmission of a message, towards one or more other BAs of the network, indicative that the determined remaining capacity of the BA meets the second criterion.

The total BA fluid consumption may be calculated by the wireless device according to the information. The remaining volume of BA fluid and/or the remaining runtime of the BA may be calculated by the wireless device.

Remaining capacity of the BA may refer to a remaining volumetric fluid capacity (e.g., a volume of breathing gas in free air) of the BA. Remaining capacity of the BA may alternatively, or additionally, refer to a time period of fluid remaining (e.g., a remaining runtime of the user using the BA, for example, expressed in minutes). The remaining capacity may, for example, be a capacity of the BA remaining at the time the remaining capacity is determined. For example, the remaining capacity of the BA may correspond to the remaining capacity of the BA at the point in time at which the incident, as referred to herein, occurred.

The method may further comprise receiving the information from the BA via the network node. The information may be transmitted wirelessly. For example, the BA may communicate with the network node via a Wi-Fi and/or a Bluetooth network.

The method may further comprise displaying, via a screen of the wireless device, the time discrete parameter. The screen of the wireless device may be a touchscreen. For example, the wireless device may be a tablet computer comprising a touchscreen. The touchscreen may be configured to display the time discrete parameter. Other information may also be displayed via the screen of the wireless device. The wireless device may enable the operator to interact with the information displayed. In examples in which the screen of the wireless device is a touchscreen, the operator may interact with the information displayed via the touchscreen. For example, the operator may be able to filter through a list of BAs or users using the (e.g., touchscreen of the) wireless device. Alternatively, or in addition, the operator may be able to sort a list of BAs or users by one or more parameters.

The user may be an emergency service personnel. The emergency service personnel may be a firefighter. The user of the BA may be referred to herein as a “wearer” of the BA.

In another aspect, there is provided a wireless device comprising processing circuitry configured to operate in accordance with the method disclosed herein.

In a further aspect, there is provided a computer program product, embodied on a non-transitory machine-readable medium, comprising instructions which are executable by processing circuitry to cause the processing circuitry to perform the method disclosed herein.

Thus, there is provided an improved technique for monitoring a user of a breathing apparatus of a network. The technique is improved since it enables the continuous determination of a parameter of the breathing apparatus even when the breathing apparatus experiences a loss of connectivity in the network. Advantageously, the technique described herein performs the determination conditionally depending on whether the (e.g., last received) information received from the breathing apparatus, prior to the loss of connection, meets a certain criterion. Conditionally determining the breathing apparatus parameter in this way ensures that the parameter is calculated in a manner that minimises the risk to the wearer. This prevents potentially unreliable information being used to determine the parameter associated with the breathing apparatus, and consequently reduces the risk of miscalculations which can have severe impact on the user's health and safety.

Moreover, the technique disclosed herein advantageously provides continuity to a user (e.g., an ECO) of the wireless device during an incident, by ensuing the user has access to necessary and/or useful information which can be acted on to coordinate a deployment (e.g., an emergency response). The technique disclosed herein advantageously provides necessary and/or useful information to the user in the event that a breathing apparatus cannot be reached on the network. In particular, the techniques disclosed herein provide for automatically determining necessary and/or useful information in response to an incident occurring.

The techniques disclosed herein are also advantageous in situations involving an emergency response, as they enable a user (e.g., the ECO) of the wireless device to focus on the emergency response, rather than having to spend time manually determining breathing apparatus parameters. In particular, the techniques disclosed herein obviate the need for the user to calculate parameters associated with a breathing apparatus, such as retreat times and estimates of remaining breathing gas of the breathing apparatus. It will therefore be understood that the techniques disclosed herein improve the safety of the user of the breathing apparatus (e.g., firefighters). As a result, the techniques disclosed herein also improve the likelihood of success of an emergency response involving such a user of a breathing apparatus.

### BRIEF DESCRIPTION OF THE DRAWINGS

Exemplary embodiments of the disclosure will now be described, by way of example, and with reference to the accompanying drawings, in which:

FIG. 1 shows a schematic illustration of a wireless device according to an embodiment;

FIG. 2 shows a block diagram of a network comprising a wireless device, a base station, and a breathing apparatus;

FIG. 3A shows a block diagram of a method according to an embodiment; and

FIG. 3B shows a block diagram of a method according to a further embodiment.

### DETAILED DESCRIPTION OF THE DRAWINGS

As mentioned above there is provided herein methods for monitoring a user of a breathing apparatus of a network.

As such, the methods described herein involve a breathing apparatus (BA). The breathing apparatus referred to herein can be configured to initiate transmission of information (e.g., signals) and/or receive information. For example, the BA referred to herein can be configured to initiate transmission of information towards the network node referred to herein. The BA referred to herein may be any type of BA. More specifically, the BA referred to herein may be any type of apparatus (e.g., device) which is worn by a wearer (user) of the BA in order to provide a supply of breathable gas (e.g., air) to the wearer. As such, a BA can be advantageously utilised in an atmosphere that is immediately dangerous to life or health. In an example, the BA referred to herein may be a self-contained breathing apparatus (SCBA) and/or a compressed air breathing apparatus (CABA). The BA referred to herein may be a closed-circuit BA. Alternatively, the BA referred to herein may be an open-circuit BA. The BA referred to herein may comprise a lung demand regulator, a face mask, a compressed breathing gas tank, a control system, a first stage breathing circuit, a second stage breathing circuit, and/or a support frame, or any combination thereof.

The methods described herein are performed by a wireless device. The wireless device may be any type of wireless device. More specifically, the wireless device referred to herein may be any device configured to communicate wirelessly with one or more other entities (e.g., of the network referred to herein, such as the network node referred to herein). For example, the wireless device may be a user equipment (UE). The wireless device referred to herein can include, but is not limited to, a smart device such as a smartphone or a tablet. The wireless device can be configured to run an application (or “app”) which, for example, enables the wireless device to communicate with the network node. The application may provide a user of the wireless device (e.g., an entry control officer, “ECO”) with the ability to manage, control, and/or coordinate an emergency response, and in particular to monitor the status of BA and/or users of the BA involved in an incident (i.e., a loss of connectivity) as described herein. The wireless device may be configured to enable the user to create, edit and/or view emergency response information. For example, the wireless device may be configured to enable the user of the wireless device to view one or more BAs of the network (e.g., deployed in an emergency response). Alternatively, or in addition, the wireless device may be configured to determine one or more parameters of the BA when the BA loses connectivity to the network node (e.g., becomes out-of-range of the network node and/or the wireless device) and provide such parameters to the user of the wireless device. As such, an activity involving the user of the breathing apparatus (e.g., an emergency and/or an emergency response) may be monitored and managed (e.g., centrally) using the wireless device.

The methods referred to herein also involve a network node. The network node may be any type of network node. More specifically, the network node may be a base station of the network described herein. The network node referred to herein may be configured to route communications between the wireless device and the BA. Herein, the network node can be any entity of the network which is configured to act as a transceiver between a wireless device and a BA. Thus, in some examples, the network node referred to herein may be configured to operate as a repeater device between different entities of the network referred to herein. The network node referred to herein can be configured to receive communications from the wireless device and/or the BA. The network node referred to herein can be configured to initiate transmission of information towards the wireless device and/or the BA. The network node can be referred to herein as a “hub” or a “base station” (e.g., of the network).

Herein, the term “initiate” can mean, for example, cause or establish. Thus, any reference to an entity (e.g., the wireless device) “initiating transmission” will be understood to mean that the entity (e.g., the processing circuitry of the entity) can be configured to itself transmit (e.g., via a communications interface of the entity) or can be configured to cause another entity to transmit.

The techniques described herein can be used in respect of any network, such as any communications or telecommunications network, e.g., cellular network. The network referred to herein may be a radio network. For example, the network referred to herein may be a 2.4 GHz radio network. In some examples, the network may comprise a Wi-Fi network (e.g., based on the Institute of Electrical and Electronics Engineers (IEEE) 802.11 family of standards). Alternatively, or in addition, the network may comprise a Bluetooth network (e.g., based on the IEEE 802.15.1 family of standards). Any one or more of the BA referred to herein, the wireless device referred to herein, and the base station referred to herein may communicate (e.g., directly, or indirectly) via the network described herein.

The incident corresponding to a loss of connection between the BA and the network node may involve the breathing apparatus becoming out-of-range of the network node during an emergency response. The incident corresponding to a loss of connection between the BA and the network node may additionally, or alternatively, involve a loss of connection resulting from a fault in the network described herein and/or a fault in one or more entities of the network described herein. A fault, as referred to herein, may be a physical (e.g., electrical, or mechanical) fault and/or a logical (e.g., software, or firmware) fault.

An emergency response, as referred to herein, may be any type of emergency response. More specifically, an emergency response may be any response which involves the addressing and/or resolving of an emergency. An emergency, as referred to herein, can be an urgent, unexpected and/or dangerous situation that poses an immediate risk to health, life, property and/or environment. An emergency may require urgent intervention to prevent a worsening of the situation. Examples of the emergencies referred to herein include, but are not limited to, emergencies which pose a danger to life, a danger to health, and/or a danger to the environment. For example, the emergency referred to herein may include a fire related incident (e.g., a building fire, a forest fire, a car fire, etc.). Alternatively, or in addition, the emergency referred to herein may involve hazardous material operations (e.g., dealing with substances which are a risk to health, safety, property, and/or the environment).

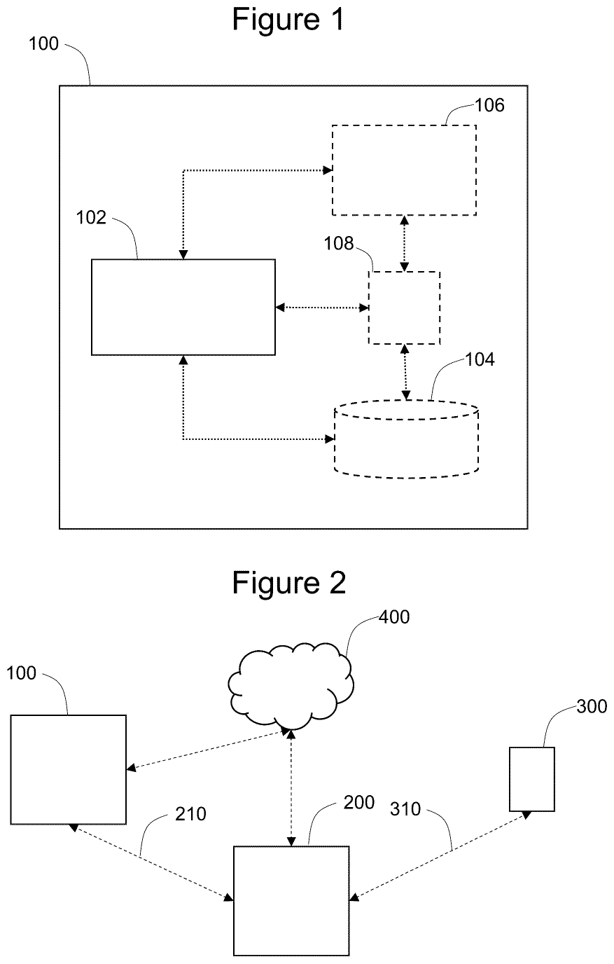

FIG. 1 illustrates a wireless device 100 according to an embodiment. The wireless device 100 can be used for monitoring a BA and/or a user of a BA in a network.

As illustrated in FIG. 1, the wireless device 100 comprises processing circuitry (or logic) 102. The processing circuitry 102 controls the operation of the wireless device 100 and can implement the method described herein in respect of the wireless device 100. The processing circuitry 102 can be configured or programmed to control the wireless device 100 in the manner described herein.

The processing circuitry 102 can comprise one or more hardware components, such as one or more processors (e.g., one or more microprocessors, one or more multi-core processors, and/or one or more digital signal processors (DSPs)), one or more processing units, one or more processing modules, and/or one or more controllers (e.g., one or more microcontrollers). The one or more hardware components can be arranged on one or more printed circuit board assemblies (PCBAs) contained in one or more housing components. The one or more hardware components may be configured or programmed (e.g., using software or computer program code) to perform the various functions described herein in respect of the wireless device 100. In particular implementations, each of the one or more hardware components can be configured to perform, or is for performing, individual or multiple steps of the method described herein in respect of the wireless device 100. The processing circuitry 102 can be configured to run software to perform the method described herein in respect of the wireless device 100. The processing circuitry 102 can thus be implemented in numerous ways, with software and/or hardware, to perform the various functions described herein in respect of the wireless device 100.

Briefly, the processing circuitry 102 of the wireless device 100 is configured to, in response to determining that an incident has occurred, determining a time discrete parameter associated with the BA. The incident corresponds to a loss of connection between the BA and the network node. The determination is based on whether information, obtained from the BA prior to the occurrence of the incident, meets a first criterion. The information comprises user breathing rate information.

As illustrated in FIG. 1, the wireless device 100 may optionally comprise a memory 104. Alternatively, the memory 104 may be external to (e.g., separate to or remote from) the wireless device 100. The memory 104 may comprise any type of non-transitory machine-readable medium, such as at least one cache or system memory. The memory 104 may comprise a volatile or a non-volatile memory. Examples of the memory 104 include, but are not limited to, a random access memory (RAM), a static RAM (SRAM), a dynamic RAM (DRAM), a read-only memory (ROM), a programmable ROM (PROM), an erasable PROM (EPROM), and an electrically erasable PROM (EEPROM), and/or any other memory.

The processing circuitry 102 can be communicatively coupled (e.g., connected) to the memory 104. The processing circuitry 102 may be configured to communicate with and/or connect to the memory 104. The memory 104 may be for storing program code or instructions which, when executed by the processing circuitry 102, cause the wireless device 100 to operate in the manner described herein. For example, the memory 104 may be configured to store program code or instructions that can be executed by the processing circuitry 102 to cause the wireless device 100 to operate in accordance with the method described herein in respect of the wireless device 100. Alternatively, or in addition, the memory 104 can be configured to store any information, data, messages, requests, responses, indications, notifications, signals, or similar, that are described herein. The processing circuitry 102 may be configured to control the memory 104 to store information, data, messages, requests, responses, indications, notifications, signals, or similar, that are described herein.

As illustrated in FIG. 1, the wireless device 100 may optionally comprise a user interface 106. The user interface 106 can be configured to render (or output, display, or provide) information required by or resulting from the method described herein. For example, the user interface 106 may be configured to render (or output, display, or provide) any information, data, messages, requests, responses, indications, notifications, signals, or similar, that are described herein. Alternatively, or in addition, the user interface 106 can be configured to receive a user input. For example, the user interface 106 may allow a user to manually enter information or instructions, interact with, and/or control the wireless device 100. Thus, the user interface 106 may be a user interface that enables the rendering (or outputting, displaying, or providing) of information and/or that enables a user to take action in relation to an emergency and/or to provide a user input. For example, the user interface 106 may be configured to display information indicative of a breathing rate of a user of a BA. The user interface 106 may be configured to display information indicative of a plurality of breathing rates of a plurality of respective users of different BAs. The user interface 106 may additionally or alternatively be configured to display information indicative of one or more additional characteristics of one or more BAs and/or of their respective users.

The user interface 106 may comprise one or more components for rendering information and/or one or more components that enable the user to provide a user input. The one or more components for rendering information can comprise one or more visual components (e.g. a display or display screen, a graphical user interface (GUI) such as a touch screen, one or more lights such one or more light emitting diodes (LEDs), and/or any other visual component), one or more audio components (e.g. one or more speakers, and/or any other audio component), and/or one or more tactile/haptic components (e.g. a vibration function, or any other haptic/tactile feedback component), or any other user interface, or combination of user interfaces. The one or more components that enable the user to provide a user input can comprise one or more visual components (e.g. one or more switches, one or more buttons, a keypad, a keyboard, a mouse, a graphical user interface (GUI) such as a touch screen, and/or any other visual component), and/or one or more audio components (e.g. one or more microphones, and/or any other audio component), and/or one or more tactile/haptic components (e.g. a vibration function, or any other haptic/tactile feedback component), or any other user interface, or combination of user interfaces.

As illustrated in FIG. 1, the wireless device 100 may optionally comprise a communications interface (or communications circuitry) 108. The communications interface 108 can be communicatively coupled (e.g., connected) to the processing circuitry 102, the memory 104, and/or the user interface 106. Although the communications interface 108 and the user interface 106 are illustrated as separate interfaces, in other embodiments, the communications interface 108 may be part of the user interface 106. The processing circuitry 102 may be configured to communicate with and/or connect to the communications interface 108. In some embodiments, the processing circuitry 102 can be configured to control the communications interface 108 to operate in the manner described herein. The communications interface 108 can be for enabling the wireless device 100, or components of the wireless device 100 (e.g., the processing circuitry 102, the memory 104, the user interface 106, and/or any other components of the wireless device 100), to communicate with and/or connect to each other and/or one or more other components.

For example, the communications interface 108 may be operable to allow the processing circuitry 102 to communicate with and/or connect to the memory 104 and/or vice versa. Similarly, the communications interface 108 may be operable to allow the processing circuitry 102 to communicate with and/or connect to the user interface 106 and/or vice versa. Similarly, the communications interface 108 may be operable to allow the processing circuitry 102 to communicate with and/or connect to any one or more other entities (e.g., the BA, the wireless device, the network node, or any other entity of the network) referred to herein whether via the network described herein or otherwise. The communications interface 108 may be operable to allow the processing circuitry 102 to communicate with and/or connect to the cloud server referred to herein. The communications interface 108 can be configured to transmit and/or receive information, data, messages, requests, responses, indications, notifications, signals, or similar, that are described herein. The processing circuitry 102 may be configured to control the communications interface 108 to transmit and/or receive information, data, messages, requests, responses, indications, notifications, signals, or similar, that are described herein.

The communications interface 108 may enable the wireless device 100, or components of the wireless device 100, to communicate and/or connect in any suitable way. For example, the communications interface 108 may enable the wireless device 100, or components of the wireless device 100, to communicate and/or connect wirelessly, via a wired connection, or via any other communication (or data transfer) mechanism. In some wireless implementations, for example, the communications interface 108 may enable the wireless device 100, or components of the wireless device 100, to use radio frequency (RF), Wi-Fi, Bluetooth, or any other wireless communication technology to communicate and/or connect.

Although the wireless device 100 is illustrated in FIG. 1 as comprising a single memory 104, it will be appreciated that the wireless device 100 may comprise at least one memory (i.e., a single memory or a plurality of memories) 104 that operate in the manner described herein. Similarly, although the wireless device 100 is illustrated in FIG. 1 as comprising a single user interface 106, it will be appreciated that the wireless device 100 may comprise at least one user interface (i.e., a single user interface or a plurality of user interfaces) 106 that operate in the manner described herein. Similarly, although the wireless device 100 is illustrated in FIG. 1 as comprising a single communications interface 108, it will be appreciated that the wireless device 100 may comprise at least one communications interface (i.e., a single communications interface or a plurality of communications interfaces) 108 that operate in the manner described herein. It will also be appreciated that FIG. 1 only shows the components required to illustrate an embodiment of the wireless device 100 and, in practical implementations, the wireless device 100 may comprise additional or alternative components to those shown.

In some embodiments, the wireless device 100 may comprise the network node described herein. In this way, the wireless device 100 and network node may be part of the same device. In examples in which the wireless device 100 and the network node are comprised in a single device, the wireless device 100 and the network node may share (power, networking, processing, memory etc.) infrastructure. The wireless device 100 and the network node may be mechanically, electrically, and/or otherwise connected together.

FIG. 2 illustrates a schematic view of a network comprising a wireless device 100, a network node 200, and a BA 300 in accordance with an embodiment. As illustrated by arrow 310 of FIG. 2 (and as will be described in more detail below), the BA 300 can transmit information, for example, relating to a status of the BA 300 and/or a status of the user of the BA 300. As also illustrated by arrow 310 of FIG. 2, The network node 200 can obtain (e.g., receive) the information from the BA 300. The network node 200 may act as a transceiver to (re)transmit the information received from the BA 300. Indeed, as illustrated by arrow 210 of FIG. 2, the network node 200 may (re)transmit the information to the wireless device 100. The wireless device 100 may thus obtain (e.g., receive) the information (originally obtained from the BA 300) from the network node 200. It will be understood that the information (re)transmitted by the network node 200 to the wireless device 100 may comprise the same information as received by the network node 200 from the BA 300. In some examples, the information (re)transmitted by the network node 200 may be parsed, formatted and/or structured (e.g., by the network node 200) in a different way to that of the information received by the network node 200. For example, the transmission of information as described with reference to arrow 310 of FIG. 2 may be performed wirelessly via a radio network, whereas the (re) transmission of information as described with reference to arrow 210 of FIG. 2 may be performed wirelessly via a Wi-Fi network. The network node 200 may perform a conversion of the structure of the information received from the BA 300 to a format suitable for (re) transmission to the wireless device 100. It will be understood that the information (e.g., transmitted as described with reference to arrow 210 and/or 310) may be compressed (in any way) or uncompressed. Compression of the information as received by the network node 200 may be the same or different as any such compression of the information transmitted by the network node 200. In examples in which the information received by the network node 200 from the BA 300 comprises compressed information, the network node 200 may be capable of decompressing and/or recompressing the information for (re) transmission to the wireless device 100. As such, the method discussed herein may comprise the wireless device 100 receiving the information from the BA 300 via the network node 200.

The wireless device 100 (e.g., the processing circuitry 102 of the wireless device 100) may be capable of decompressing, decoding, and/or decrypting the information (e.g., received from the network node 200). It will be understood that the wireless device 100 may additionally be capable of receiving communications from the BA 300.

It will be appreciated that, during a deployment of the BA 300 (e.g., a response to an emergency), the BA 300 may be connected to (e.g., within range of) the network node 200. As such, the network node 200 is capable of receiving information from the BA 300. However, it will also be appreciated that the BA 300 may (e.g., routinely) lose connection to the network node. For example, the BA 300, and/or the user of the BA 300, may move out of range of the network node 200. In this case, the user of the BA 300 may be referred to as a “non-telemetry” user. In a particular example, the user of the BA 300 may be a firefighter using the BA 300, and a loss of connection may occur as the firefighter moves around the scene of a fire. It is in these situations, or “incidents” as they are referred to herein, where a loss of connection can occur. As a consequence, information (such as that described with reference to arrow 310 of FIG. 2 above) cannot be received by the network node 200. As mentioned herein, the determination of a time discrete parameter associated with the BA is performed in response to determining that an incident has occurred. This automatic determination in response to a loss of connection of the BA ensures that no time is wasted in determining the parameter associated with the BA. This is advantageous as it reduces the likelihood of the parameter being incorrectly determined, or not determined at all (e.g., for some period of time).

As shown in FIG. 2, in some embodiments, the network referred to herein may comprise a cloud server 400 with which the wireless device 100 and/or the network node 200 may communicate. In some embodiments, the cloud server 400 can comprise a persistent memory capable of storing information. For example, the cloud server 400 may store a copy of information received by the network node 200 (e.g., from the BA 300). In some embodiments, the cloud server 400 can enable the wireless device 100 and the network node 200 to communicate via the cloud server 400 (e.g., even when the wireless device 100 and network node 200 are not proximate to one another). The cloud server 400 referred to herein can be a remote data server (e.g., a centralised data centre). The cloud server 400 referred to herein can be a local data server (e.g., a server deployed at the site of an emergency).

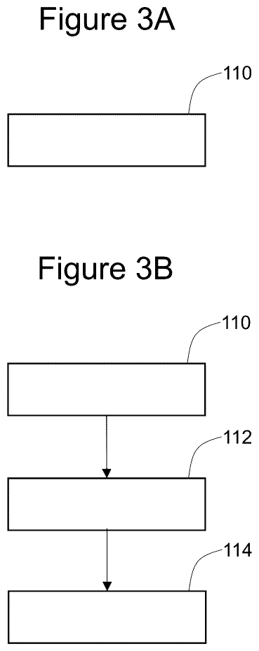

FIG. 3A illustrates a method according to an embodiment of the present disclosure. The method is for monitoring a user of a BA 300 of a network. The wireless device 100 described herein (e.g., with reference to any of FIGS. 1 and 2) can be configured to operate in accordance with the method of FIG. 3A. For example, the method can be performed by or under the control of the processing circuitry 102 of the wireless device 100. The method described herein may be a computer-implemented method.

With reference to FIG. 3A, at block 110, in response to determining that an incident has occurred, wherein the incident corresponds to a loss of connection between the BA 300 and the network node 200, a time discrete parameter associated with the BA 300 is determined. More specifically, in response to determining that an incident has occurred, the wireless device 100 (e.g., the processing circuitry 102 of the wireless device 100) determines a time discrete parameter associated with the BA 300. It will therefore be understood that the wireless device 100 may automatically determine a time discrete parameter associated with the BA 300 in response to determining that an incident has occurred.

In some examples, the wireless device 100 may determine (e.g., itself) that the incident has occurred. The wireless device 100 can determine that an incident has occurred in one or more ways. For example, the wireless device 100 can determine that an incident has occurred by receiving a message from the network node 200. As such, the network node 200 can transmit the message to the wireless device 100. The message may be indicative that the connection between the network node 200 and BA 300 has been lost. The message may comprise information indicative of a loss of connection between the BA and the network node 200. The message may comprise information indicative of the time at which the network node 200 lost connection with the BA 300. The network node 200 may detect a loss of connection between the network node 200 and the BA 300 by detecting an absence of a (e.g., received) signal (e.g., via the communication path illustrated by arrow 310 of FIG. 2). The signal may comprise information from the BA, as described herein. The network node 200 may be configured to expect to receive the signal continuously and/or at periodic intervals. Where the network node 200 does not receive the signal when expected, the network node 200 may transmit a message indicating the incident has occurred to the wireless device 100.

In some embodiments, the wireless device 100 may determine that an incident has occurred in addition to, or without, the message being sent by the network node 200. For example, the wireless device 100 can determine that an incident has occurred based on communication(s) (e.g., or the lack thereof) received from the network node 200. In a particular example, the wireless device 100 can detect if an incident has occurred by determining how long ago the last information relating to the BA 300 was obtained from the network node 200. The wireless device 100 may determine that an incident has occurred if a set period of time elapses in which no information is obtained from the BA. For example, the wireless device 100 may compare the time when the last information was obtained from the BA 300 (i.e., the set period of time) to a set time interval. If the set period of time is greater than or equal to the set time interval, then the wireless device 100 may determine that an incident has occurred. The set time interval can be large enough so as to avoid unnecessarily triggering the wireless device 100 to execute the method described herein during momentary lapses in connection between the BA 300 and the network node 200 and/or between the network node 200 and the wireless device 100. Such momentary lapses may be a result of a firefighter briefly moving behind an obstruction and may last no more than several seconds. The set time interval can be small enough so as to avoid a condition where the last information obtained by the wireless device 100 from the BA 300 being “out of date” or, in other words, no longer reflective of, or likely to be reflective of, the current status of the user and/or the BA 300. For example, the set time interval may be at least 1 second. The set time interval may be between 0 and 255 seconds. The set time interval may be 50 seconds.

In response to determining that an incident has occurred, according to any of the methods described herein (and indeed other applicable methods), a time discrete parameter associated with the BA 300 is determined. More specifically, once the wireless device 100 has determined that an incident has occurred, the wireless device 100 determines a time discrete parameter associated with the BA 300. The time discrete parameter is determined based on whether information, obtained from the BA 300 prior to the occurrence of the incident, meets a first criterion. In particular, the wireless device 100 determines the time discrete parameter based on whether the information obtained by the wireless device 100 from the BA 300 prior to the occurrence of the incident meets a first criterion.

It will be appreciated that the information obtained from the BA 300 prior to the occurrence of the incident may be the last (e.g., the most recent) information obtained from the BA 300 prior to the incident occurring. The information (as it will be referred to herein) may represent a collection of data points corresponding to a plurality of moments in time prior to the incident occurring. In this way, the information may represent an average or trend in the data points prior to the incident occurring. Equally, the information may represent a single data point corresponding to a last moment of time prior to the incident occurring.

The information referred to herein comprises a user breathing rate information. The information referred to herein may comprise additional information. For example, the information referred to herein may comprise to a status of the user and/or a status of the BA 300. The user breathing rate information can be determined by the BA 300. As described herein, for example with reference to arrows 310 and 210 of FIG. 2, the wireless device may obtain the information from the BA via the network node. As such, the BA 300 can transmit the information to the network node 200 and on to the wireless device 100. The user breathing rate information may be measured by a sensor (e.g., a flow sensor, a pressure sensor, etc) comprised in any part of the BA 300 (e.g., lung demand regulator, first stage circuit, second stage circuit, pressurised breathing gas tank, etc). The user breathing rate information may comprise a volume per unit time (e.g., a flow rate), such as a volume of breathing gas in free air used (e.g., by the user) per minute. The user breathing rate information may alternatively, or additionally, comprise a number (e.g., whether actual or averaged over a set period) of breaths taken by the user per unit time, e.g., breaths per minute. It will be understood that both the volume per unit time and the number of breaths taken by the user per unit time are capable of reflecting a user breathing rate. It will be understood that, although the information may reflect, for instance, a “per minute” breathing rate, the information may be obtained (e.g., by the wireless device 100) from the BA 300 continuously and/or at a frequency other than once per minute. The wireless device 100 can therefore, in some examples, obtain (e.g., receive) the information at a rate different that the format of the user breathing rate comprised therein.

The user breathing rate information described herein can comprise information indicative of a fluid consumption of the BA 300. It will be understood that fluid consumption may refer to a volume (e.g., in free air) of breathing gas consumed by the BA 300. The fluid consumption may be expressed as an absolute volume, may be expressed as a percentage of the total capacity of the BA 300, and/or may be expressed as a time value (e.g., five minutes of breathing gas-referring to a volume of gas consumed during five minutes of use of the BA 300). The BA 300 fluid consumption may be an estimated or measured BA 300 fluid consumption. The BA 300 fluid consumption may be measured by the BA 300. Alternatively, the BA 300 may measure a parameter which is then used to determine (e.g., by the wireless device 100) the BA 300 fluid consumption. For instance, the user breathing rate information may comprise information indicative of the number of breaths taken by the user per minute. The user breathing rate information may also comprise information indicative of the volume of fluid consumed by the user per breath. Therefore, it will be clear that, in some examples, the user breathing rate information can be indicative of the BA 300 fluid consumption. In other words, the BA 300 fluid consumption may be determined based on the user breathing rate information. It will be appreciated that other components of the user breathing rate information could be included and/or other combinations utilised to arrive at the same result. The “fluid consumption” of the BA 300 will be understood to mean a combination of the fluid consumed by the user of the BA 300 through inhalation, and any unused fluid or fluid lost by the BA 300.

Where an incident occurs, the BA 300 may continue to determine the user breathing rate information. The breathing rate information determined by the BA 300 can be stored in a memory of the BA 300. The BA 300 may then transmit the stored user breathing rate information at a later time (e.g., in response to re-establishing connection to the network node 200). The stored user breathing rate information may alternatively, or additionally, be available to be extracted from the memory of the BA 300 (e.g., for later analysis).

The information referred to herein can exclusively comprise user breathing rate information or comprise user breathing rate information in addition to other information. The other information can comprise, for example, other physiological parameters of the user of the BA 300 (e.g., heart rate, blood oxygen saturation, body temperature, etc.), BA 300 status information, and/or BA 300 identification information (e.g., user ID, user name, equipment ID, equipment model etc.).

The time discrete parameter referred to herein can be any parameter associated with a condition and/or a status of the BA 300 and/or of the user of the BA 300. In some embodiments, the time discrete parameter can be a breathing rate of the user. In some embodiments, the time discrete parameter can be a time discrete pressure value associated with the BA 300. For example, the time discrete parameter may be a time discrete pressure value of the pressurised breathing gas tank of the BA 300 and/or a time discrete pressure value of any other circuit or component of the BA 300. The term “time discrete parameter” should be understood to mean a parameter measurable as a discrete value at discrete increments of time.

According to some examples of the method described herein, the wireless device 100 may compare the information to the first criterion and, if the information meets the first criterion, the time discrete parameter can be determined using the information. Otherwise, if the information does not meet the first criterion, the time discrete parameter can be determined using pre-configured breathing rate information. The pre-configured breathing rate information may comprise a pre-configured breathing rate (as will be described in more detail later). The first criterion may be met if the user breathing rate information comprised in the information corresponds to a user breathing rate that is greater than or equal to a threshold breathing rate.

The first criterion can be a criterion that is fixed in value and/or type for the duration of the incident. The first criterion can be a dynamically adjustable criterion. For example, the first criterion may be adjustable (e.g., by the wireless device 100 in response to an input received via the user interface 106 of the wireless device) during the incident. In a particular example, an ECO may use the wireless device 100 to (re) configure the first criterion. It will be appreciated that, during an emergency response, the priorities and/or concerns of the ECO in respect of a user (e.g., a firefighter) of the BA 300 may change over time. Therefore, enabling the ECO to modify the first criterion allows for a greater degree of flexibility and therefore user safety.

Where the wireless device 100 determines that the information meets the first criterion, the time discrete parameter is determined using the information. As mentioned herein, the information comprises user breathing rate information. The time discrete parameter can be calculated and/or estimated based on the information. As discussed herein, in some embodiments, the time discrete parameter is a time discrete pressure value.

The time discrete pressure value can be determined by the wireless device 100 based on the information. For example, where the user breathing rate information comprises a breathing rate of the user (e.g., breaths per minute), the wireless device 100, can determine a pressure as the time discrete parameter. The determined pressure can correspond to a pressure of the remaining breathing gas inside a pressurised breathing gas tank of the BA 300. In some examples, the wireless device 100 can estimate a volume of breathing gas in free air consumed by the user, based on the user breathing rate information. The volume of consumed breathing gas can then be used to estimate a volume of remaining breathing gas, assuming a known starting volume of breathing gas. Given a known remaining volume of breathing gas, the pressure of the remaining breathing gas can be determined by the wireless device 100. Before a user is deployed to respond to an emergency, the volume of breathing gas contained within the user's BA 300 may be determined (e.g., and stored) by the wireless device 100. For example, a user (e.g., an ECO) of the wireless device 100 may input, to the wireless device 100, an initial volume of breathing gas contained within the BA 300. The volume can then be referred to according to the method described herein. Alternatively, or in addition, the wireless device 100 may receive information indicative of the initial volume of breathing gas contained within the BA 300 from the BA 300 (e.g., via the network node 200). The wireless device 100 may receive this information from the BA 300 in response to an activation of the BA 300. In some embodiments, the wireless device 100 may communicate with the cloud server 400 to thereby store information obtained by the wireless device 100. For example, the wireless device 100 may communicate with the cloud server 400 to store information indicative of the initial volume of breathing gas contained within the BA 300 (e.g., as input by a user of the wireless device 100) at the cloud server 400. In some embodiments, the wireless device 100 may receive information indicative of the initial volume of breathing gas contained within the BA 300 from the cloud server 400.

It will be appreciated that knowledge of the remaining breathing gas in a BA 300 can be very useful to an operator of the wireless device 100 (e.g. an ECO) during deployment of the user of the BA 300 (e.g., during an emergency response). In this way, the operator of the wireless device is aware of the status of the individuals (e.g., firefighters) and equipment they are managing in order to guarantee the safety of the individuals and ensure a successful outcome to the response.

Where the wireless device 100 determines that the information does not meet the first criterion, the time discrete parameter can be determined using pre-configured breathing rate information. For example, if the information does not meet the first criterion, the user breathing rate information comprised in the information obtained from the BA 300 is not used to determine the time discrete parameter. As such, according to some examples, the pre-configured breathing rate information can be thought of as replacing the user breathing rate information, as disclosed herein, if the information does not meet the first criterion. In some embodiments, the pre-configured breathing rate information is determined using a formula and/or a lookup table. As such, the time discrete parameter can be determined based on the formula and/or the lookup table. Alternatively, or in addition, the pre-configured breathing rate information may be based on one or more (e.g., stored) characteristics of the user of the BA 300. In examples in which the time discrete parameter is a time discrete pressure value, the one or more characteristics of the user can be used in relation to the formula and/or lookup table to determine a breathing rate of the user, which can in turn be used to determine a remaining pressure in the BA 300 as the time discrete pressure value. The one or more characteristics of the user can include one or more of a height, a weight, an age, etc., of the user. The formula and/or lookup table may be stored in the memory 104 of the wireless device 100 or may be entered manually by the ECO via the user interface 106 of the wireless device 100. In some embodiments, the formula and/or lookup table may be stored in the cloud server 400. The wireless device 100 may be configured to communicate with the cloud server 400 to retrieve the formula and/or lookup table stored on the cloud server 400.

By determining the time discrete parameter using the information when the user breathing rate comprised in the information meets the first criterion, the method advantageously ensures that the time discrete parameter does not represent an underestimation of the user's breathing rate and/or an overestimation of the remaining volume of breathing gas in the BA 300.

Equally, by determining the time discrete parameter using pre-configured breathing rate information when the information does not meet the first criterion (i.e., instead of using the information obtained from the BA 300), the method advantageously prevents an underestimation of the user's (e.g., the firefighter's) consumption rate of breathing gas, when the user's breathing rate is below the breathing rate of the pre-configured breathing rate information. Therefore, the method advantageously prevents an overestimation of remaining breathing gas contained in the BA 300.

In both cases, the methods disclosed herein provide for improved reliability (e.g., safety) of information available to, for instance, an ECO during an emergency response. In particular, where the time discrete parameter is a time discrete pressure value, the time discrete pressure value is more likely to represent a) the true pressure value, and/or b) a pressure value biased towards a value corresponding to increased safety.

It will be appreciated that during an emergency response, to ensure the safety of the user of the BA 300, it is more desirable to underestimate, rather than overestimate, the volume of remaining breathing gas in the BA 300, to thereby ensure the user has time to get to safety without running out of breathing gas. Therefore, the methods disclosed herein advantageously provide a means for providing a more useful and reliable (e.g., more meaningful) remaining volume/pressure value of the BA 300.

In some embodiments, the pre-configured breathing rate information comprises a constant breathing rate parameter. The constant breathing rate parameter may represent an industry standard breathing rate parameter (e.g., a constant breathing rate representative of a typical breathing rate of a firefighter during an emergency response). The constant breathing rate parameter may be derived from a breathing profile customised to the user of the BA 300. The breathing profile may comprise information relating to a typical breathing rate of the user and/or a typical volume of free air per breath of the user. It will be appreciated that the breathing profile may be determined before the user of the BA is deployed in the network (e.g., to handle an emergency response). The breathing profile may be stored in the memory 104 of the wireless device 100. The breathing profile may alternatively or additionally be stored in a separate device accessible by the wireless device 100 via the network. The wireless device 100 may be capable of updating the breathing profile during an emergency response according to information obtained from the BA 300 by the wireless device 100 before an incident, as referred to herein, occurs.

As described herein, the time discrete parameter is determined based on whether the information meets the first criterion. In some embodiments, the first criterion is met if the user breathing rate information exceeds a threshold. For example, the first criterion may be met if the user breathing rate information corresponds to a user breathing rate that is greater than or equal to a threshold breathing rate. The wireless device 100 can determine whether the user breathing rate corresponding to the user breathing rate information is greater than or equal to the threshold breathing rate and thereby determine whether the first criterion is met. Therefore, the wireless device 100 can determine whether the first criterion has been met and determine the time discrete parameter using the information. In contrast, if the first criterion is not met, the wireless device 100 may determine the time discrete parameter using the pre-configured user breathing rate information, as defined herein.

According to the methods disclosed herein, the wireless device 100 may display (e.g., via the user interface 106 of the wireless device 100) the time discrete parameter. As such, a user of the wireless device 100 (e.g., an ECO) is able to view the time discrete parameter. In this way, the user of the wireless device 100 is able to take action according to the time discrete parameter (e.g., in relation to an emergency response at which the user of the BA 300 is deployed). It will be appreciated that displaying the time discrete parameter enables the user of the wireless device 100 to take action even during the incident (i.e., when the network node 200 has lost connection to the BA 300). This enables the ECO to act more quickly, rather than needing to dedicate time to manually determining parameters of the BA 300 by hand.

The threshold breathing rate referred to herein can be an industry standard breathing rate. The threshold breathing rate can additionally, or alternatively, be a breathing rate specific to the user of the BA 300. In other words, the threshold breathing rate can represent an average or typical breathing rate of one or more users and/or can represent a breathing rate specific to the user of the BA 300. The threshold breathing rate may be determined by measuring an average (e.g., typical) number of breaths taken by a user, or group of users, during a specified period. The threshold breathing rate may be determined as an average number of breaths per unit time. The threshold breathing rate may be determined as a percentile of an average breathing rate. For instance, the threshold breathing rate may correspond to a 55^{th} percentile of an average breathing rate. Therefore, in such an embodiment, the first criterion is met when the user breathing rate information corresponds to a user breathing rate that is greater than or equal to the 55^{th} percentile of measured breathing rates. In examples in which the threshold breathing rate corresponds to the 55^{th} percentile of the average breathing rate, the threshold breathing rate can correspond to a breathing rate that is just over half of the average breathing rate. As such, the threshold breathing rate can correspond to a (e.g.

unreasonably) low breathing rate. It will be appreciated that other percentiles and/or methods for determining the threshold breathing rate are applicable to this disclosure. The threshold breathing rate may correspond to a flow rate of breathing gas of between 10 l/min and 100 l/min. In some embodiments, the threshold breathing rate may correspond to a flow rate of breathing gas of 40 l/min.

The methods described herein may further comprise an additional step, as in FIG. 3B. In some embodiments the method further comprises step 112 of determining a remaining capacity of the BA 300 based on the time discrete parameter. The remaining capacity of the BA 300 can represent a remaining volume of breathing gas (e.g., in free air) available to the user of the BA 300. The remaining capacity of the BA 300 can additionally, or alternatively, represent a remaining breathing time of the user in relation to the BA 300. It will therefore be understood that references to “capacity” can relate to a volumetric capacity and/or a time-based capacity. For example, the remaining capacity of the BA 300 may be indicative of a “time to whistle” for the BA 300. Where the wireless device 100 determines a remaining capacity of the BA 300, the wireless device 100 may convey an indication of the determined remaining capacity. For example, the wireless device 100 may be configured to display (e.g., via the user interface 106 of the wireless device 100) the remaining capacity of the BA 300. In some embodiments, the wireless device 100 may be configured to display (e.g., a list of) a plurality of determined remaining capacities corresponding to a plurality of respective BAs. The list may be sortable by determined remaining capacity, e.g., from highest to lowest or vice versa.

In some embodiments, the remaining capacity may be determined exclusively based on the time discrete parameter. In other embodiments, the remaining capacity may be determined based on the time discrete parameter as well as the information obtained from the BA 300. This is advantageous in embodiments in which the information obtained from the BA 300 is indicative of a capacity of the BA 300 prior to the occurrence of the incident.

Turning to step 114 of the exemplary method shown in FIG. 3B, the methods disclosed herein may further comprise the step of, if the determined remaining capacity of the BA meets a second criterion, generating an alert notification indicative that the determined remaining capacity of the BA 300 meets the second criterion, and/or initiating transmission of a message, towards one or more other BAs of the network, indicative that the determined remaining capacity of the BA 300 meets the second criterion.

In embodiments where the wireless device 100 is configured to display (e.g., a list of) a plurality of determined remaining capacities corresponding to a plurality of respective BAs, the list may be configurable to emphasise BAs in the list with a determined remaining capacity which meet the second criterion. These BAs may be considered the most critical to monitor (e.g., by an ECO) as the users (e.g., firefighters) using the BAs likely have the shortest volume and/or time of breathing gas remaining. In some embodiments, the wireless device 100 may be configured to generate an alert notification indicative that the determined remaining capacity of the BA 300 meets the second criterion. Such a notification may serve to distinctly and unambiguously convey a critical status of the BA. An alert notification may take the form of one or more sensory indicators including, but not limited to, lights, sounds, haptics etc., or a combination thereof. The alert notification may be, for example, a whistle sound. The wireless device 100 can generate the alert notification itself, for instance via the user interface 106 of the wireless device 100. Alternatively, or in addition, generating the alert notification may comprise the wireless device 100 initiating transmission of the alert notification towards one or more other entities of the network (e.g., such that the notification is output by the one or more other entities). By emphasising the most critical BAs, (e.g., ECO) attention can be focussed on these BAs, thereby reducing the likelihood of the status of the BA 300 being missed and/or harm coming to the user of the BA 300 as a result.

In some cases, the wireless device 100 may initiate transmission of a message, towards one or more other BAs of the network, indicative that the determined remaining capacity of the BA 300 meets the second criterion. The wireless device 100 may be configured to transmit the message either directly to the one or more BAs and/or transmit the message to the one or more BAs via the network node 200 (e.g., which then retransmits the message to the one or more BAs). The one or more BAs which receive the message may comprise a system for alerting the BA users the BA 300 has a determined remaining capacity which meets the second criterion. For example, the BAs may comprise a light indicator, or screen, to display the received message. Therefore, the respective users of the one or more BAs are able to, in response to receiving the message, locate the user of the BA 300 with the determined remaining capacity which meets the second criterion and alert them to that fact.

The second criterion may be a threshold capacity. In such embodiments, the second criterion is met where the determined remaining capacity is less than or equal to the threshold capacity. The threshold capacity can be a percentage of the total capacity of the BA 300. For example, the threshold capacity can be 20% of the total capacity of the BA 300. Therefore, in this example, the generation of the notification referred to herein, and/or the transmission of the message to the one or more BAs, will occur once the determined remaining capacity is less than or equal to 20% of the total capacity of the BA 300. Of course, other thresholds are applicable. Indeed, in a particular example, the threshold capacity can be customisable by an ECO on a, for instance, per response and/or per firefighter basis.

It will be appreciated that an incident as referred to herein may be a temporary condition of connectivity loss between the network node 200 and the BA 300. The incident may be resolved (i.e., a connection restored) without any user input. For instance, the user of the BA 300 moving to a different location may cause re-establishment of the connection between the network node 200 and the BA 300, thereby resolving the incident. Once an incident has been resolved, the BA 300 may resume transmitting information to the wireless device 100 via the network node 200. During a period following the resumption, the BA 300 may transmit any information recorded and stored by the BA 300 (e.g., during the incident). A second incident may represent a further disconnection between the BA 300 and network node 200 which may occur after a first incident has been resolved. It will be understood that the method described herein is equally applicable to the second incident as it is to the first incident. As such, during the second incident, the method may utilise information obtained by the wireless device 100 in the period between the resolution of the first incident and the start of the second incident.

It will be appreciated by those skilled in the art that, although the disclosure has been described by way of example and with reference to one or more exemplary embodiments, it is not limited to the disclosed embodiments and alternative embodiments could be constructed and/or implemented without departing from the scope of the disclosure as defined by the appended claims.

1-15. (canceled)

16. A method for monitoring a breathing apparatus of a network, the method comprising:
establishing a connection between a wireless device of the network and a network node of the network, wherein the network node is configured to route communications between the breathing apparatus and the wireless device;
establishing a connection between the network node and the breathing apparatus;
determining that an incident has occurred, wherein the incident corresponds to a loss of connection between the breathing apparatus and the network node; and
in response to the determining that the incident has occurred:
determining a time discrete parameter associated with the breathing apparatus, wherein the determination of the time discrete parameter is based on comparing information, obtained from the breathing apparatus prior to the occurrence of the incident, with a first criterion, and wherein the information comprises user breathing rate information.

17. The method of claim 16, wherein:
if the information meets the first criterion, the time discrete parameter is determined using the information; and
if the information does not meet the first criterion, the time discrete parameter is determined using pre-configured breathing rate information.

18. The method of claim 17, wherein the pre-configured breathing rate information comprises a breathing profile of the user.

19. The method of claim 17, wherein the pre-configured breathing rate information comprises a constant breathing rate parameter.

20. The method of claim 16, wherein the time discrete parameter associated with the breathing apparatus is a time discrete pressure value.

21. The method of claim 16, wherein the determining the time discrete parameter comprises:
determining that the information meets the first criterion if, based on the comparing, the user breathing rate information comprised in the information corresponds to a user breathing rate that is greater than or equal to a threshold breathing rate; and
determining that the information does not meet the first criterion if, based on the comparing, the user breathing rate information comprised in the information corresponds to a user breathing rate that is less than the threshold breathing rate.

22. The method of claim 16, wherein the determining that the incident has occurred comprises at least one of:
receiving, from the network node, a message comprising information indicative of the loss of connection between the breathing apparatus and the network node; or
determining that a set period of time has elapsed in which no information is obtained from the breathing apparatus.

23. The method of claim 16, wherein the user breathing rate information comprised in the information comprises information indicative of a breathing apparatus fluid consumption.

24. The method of claim 16, further comprising determining, based on the time discrete parameter associated with the breathing apparatus, a remaining capacity of the breathing apparatus.

25. The method of claim 24, further comprising:
determining whether the determined remaining capacity of the breathing apparatus meets a second criterion; and
in response to determining whether the determined remaining capacity of the breathing apparatus meets the second criterion, performing at least one of:
generating, based on determining that the remaining capacity of the breathing apparatus meets the second criterion, an alert notification indicative that the determined remaining capacity of the breathing apparatus meets the second criterion; or
initiating, based on determining that the remaining capacity of the breathing apparatus meets the second criterion, transmission of a message, towards one or more other breathing apparatuses of the network, indicative that the determined remaining capacity of the breathing apparatus meets the second criterion.

26. The method of claim 16, further comprising receiving the information from the breathing apparatus via the network node.

27. The method of claim 16, further comprising displaying, via a screen of the wireless device, the time discrete parameter.

28. A wireless device comprising:
processing circuitry configured to cause, by processing one or more instructions, the wireless device to:
establish a connection between the wireless device and a network node of a network, wherein the network node is configured to route communications between a breathing apparatus and the wireless device;
determine that an incident has occurred, wherein the incident corresponds to a loss of connection between the breathing apparatus and the network node; and
in response to the determining that the incident has occurred:
determine a time discrete parameter associated with the breathing apparatus, wherein the determination of the time discrete parameter is based on comparing information, obtained from the breathing apparatus prior to the occurrence of the incident, with a first criterion, and wherein the information comprises user breathing rate information.

29. The wireless device of claim 28, wherein:
if the information meets the first criterion, the time discrete parameter is determined using the information; and
if the information does not meet the first criterion, the time discrete parameter is determined using pre-configured breathing rate information, wherein the pre-configured breathing rate information comprises one or more of:
a breathing profile of a user of the breathing apparatus; and
a constant breathing rate parameter.

30. The wireless device of claim 28, wherein the one or more instructions, when processed by the processing circuitry, further cause the wireless device to:
determine, based on the time discrete parameter associated with the breathing apparatus, a remaining capacity of the breathing apparatus;
determine whether the determined remaining capacity of the breathing apparatus meets a second criterion; and
in response to determining whether the determined remaining capacity of the breathing apparatus meets the second criterion, perform at least one of:
generating, based on determining that the remaining capacity of the breathing apparatus meets the second criterion, an alert notification indicative that the determined remaining capacity of the breathing apparatus meets the second criterion; or
initiating, based on determining that the remaining capacity of the breathing apparatus meets the second criterion, transmission of a message, towards one or more other breathing apparatuses of the network, indicative that the determined remaining capacity of the breathing apparatus meets the second criterion.

31. The wireless device of claim 28, wherein the one or more instructions, when processed by the processing circuitry, further cause the wireless device to:
display, via a screen of the wireless device, the time discrete parameter.

32. A computer program product, embodied on a non-transitory machine-readable medium, comprising instructions which are executable by processing circuitry to cause:
establishing a connection between a wireless device of a network and a network node of the network, wherein the network node is configured to route communications between a breathing apparatus and the wireless device;
determining that an incident has occurred, wherein the incident corresponds to a loss of connection between the breathing apparatus and the network node; and
in response to the determining that the incident has occurred:
determining a time discrete parameter associated with the breathing apparatus, wherein the determination of the time discrete parameter is based on comparing information, obtained from the breathing apparatus prior to the occurrence of the incident, with a first criterion, and wherein the information comprises user breathing rate information.

33. The computer program product of claim 32, wherein:
if the information meets the first criterion, the time discrete parameter is determined using the information; and
if the information does not meet the first criterion, the time discrete parameter is determined using pre-configured breathing rate information, wherein the pre-configured breathing rate information comprises one or more of:
a breathing profile of a user of the breathing apparatus; and
a constant breathing rate parameter.

34. The computer program product of claim 32, wherein the instructions are executable by the processing circuitry to further cause:
determining, based on the time discrete parameter associated with the breathing apparatus, a remaining capacity of the breathing apparatus;
determining whether the determined remaining capacity of the breathing apparatus meets a second criterion; and
in response to determining whether the determined remaining capacity of the breathing apparatus meets the second criterion, performing at least one of:
generating, based on determining that the remaining capacity of the breathing apparatus meets the second criterion, an alert notification indicative that the determined remaining capacity of the breathing apparatus meets the second criterion; or
initiating, based on determining that the remaining capacity of the breathing apparatus meets the second criterion, transmission of a message, towards one or more other breathing apparatuses of the network, indicative that the determined remaining capacity of the breathing apparatus meets the second criterion.

35. The computer program product of claim 32, wherein the instructions are executable by the processing circuitry to further cause:
displaying, via a screen of the wireless device, the time discrete parameter.
